(19) United States
(12) Patent Application Publication
(10) Pub. No.: US 2016/0321547 A1
(43) Pub. Date: Nov. 3, 2016

(54) INTELLIGENT WARDROBE PROGRAM

(71) Applicant: GLOBALFOUNDRIES INC., GRAND CAYMAN (KY)

(72) Inventors: Michael C. Johnson, Burlington, VT (US); Travis S. Longenbach, Essex Junction, VT (US); Nicolas E. Pizzuti, South Burlington, VT (US)

(21) Appl. No.: 14/700,254

(22) Filed: Apr. 30, 2015

(51) Int. Cl. G06N 5/04

(52) U.S. Cl. CPC G06N 5/04

(57) ABSTRACT

A computer receives information detailing the wardrobe of the user, including apparel and accessories, stored in a wardrobe database. The computer receives the schedule of the user and searches the schedule for keywords associated with dress codes and locational information in order to identify the dress code and locations of scheduled events. The computer cross references the determined dress code and weather conditions with suitable clothing in the wardrobe of the user then sends a signal to receivers in the wardrobe to indicate to the user which articles of clothing are appropriate for the weather and occasions of a particular day.

### TECHNICAL FIELD

The present invention relates generally to clothing, and more particularly to clothing recommendations based on weather and scheduled events.

### BACKGROUND

Obtaining current weather and future forecasts is incredibly easy, however the fast pace of modern life leads many people with little energy, time, or patience to constantly monitor changes in the weather. Failure to stay up to date on constantly changing weather conditions results in clothing choices that are ill suited to the day's forecast, sometimes leading to soiled clothing and the the jeopardizing of social and business relationships.

### SUMMARY

Embodiments of the present invention disclose a method, system, and computer program product for an intelligent wardrobe system. A computer receives information detailing the wardrobe of the user, including apparel and accessories, stored in a wardrobe database. The computer receives the schedule of the user and searches the schedule for keywords associated with dress codes and locational information in order to identify the dress code and locations of scheduled events. The computer cross references the determined dress code and weather conditions with suitable clothing in the wardrobe of the user then sends a signal to receivers in the wardrobe to indicate to the user which articles of clothing are appropriate for the weather and occasions of a particular day.

### BRIEF DESCRIPTION OF THE SEVERAL VIEWS OF THE DRAWING

FIG. 1 illustrates an intelligent wardrobe system, in accordance with an embodiment of the invention.

FIG. 2 is a flowchart illustrating the operations of the intelligent wardrobe program of FIG. 1 in determining suitable clothing based on the day and occasion, in accordance with an embodiment of the invention.

FIG. 3 is a block diagram depicting the hardware components of an intelligent wardrobe system of FIG. 1, in accordance with an embodiment of the invention.

### DETAILED DESCRIPTION

Embodiments of the present invention will now be described in detail with reference to the accompanying figures.

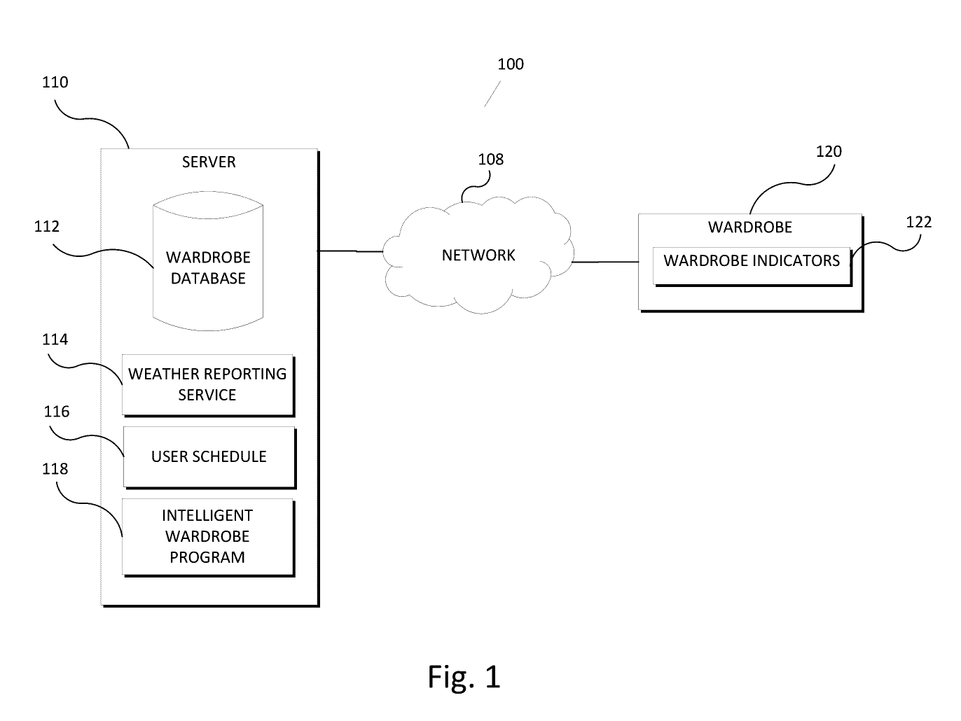

FIG. 1 illustrates an intelligent wardrobe system 100, in accordance with an embodiment of the invention. In the example embodiment, intelligent wardrobe system 100 includes wardrobe 120, network 108, and server 110.

In the example embodiment, network 108 may be the Internet, representing a worldwide collection of networks and gateways to support communications between devices connected to the Internet. Network 108 may include, for example, wired, wireless or fiber optic connections. In other embodiments, network 108 may be implemented as an intranet, a local area network (LAN), or a wide area network (WAN). In general, network 108 can be any combination of connections and protocols that will support communications between server 110 and wardrobe indicators 122.

Wardrobe 120 includes wardrobe indicators 122. In the example embodiment, wardrobe 120 is a closet, however in other embodiments, wardrobe 120 may be a free-standing closet, dresser, bureau, coat hanger, or other receptacles capable of storing clothing and clothing accessories. In the example embodiment, the clothing and accessories contained in wardrobe 120 are catalogued in an electronic database, such as wardrobe database 112, however in other embodiments, the clothing and accessories contained in wardrobe 120 may not be catalogued electronically. Additionally, in the example embodiment, wardrobe 120 is compartmentalized to group together similar clothing and accessories contained in wardrobe 120 such that the contents are organized based on both dress code as well as wearing temperature (for example, short sleeve polo shirts for business casual dress are grouped together in a particular section of wardrobe 120).

Wardrobe indicators 122 are visual guide(s) capable of indicating to a user which clothing and/or clothing accessories are suitable for a particular day and/or occasion. In the example embodiment, wardrobe indicators 122 may be light-emitting indicators that are capable of being attached to the hangers, drawers, cubbies, clothing, and other surfaces of wardrobe 120. In the example embodiment, wardrobe indicators 122 are designed such that they are capable of clipping, sticking, wrapping around, or otherwise adhering to objects temporarily. Wardrobe indicators 122 may be additionally capable of changing color to indicate the propriety of a particular article, such as illuminating red to indicate warmer clothes for the particular day or blue to indicate cooler clothes for a particular day. In the example embodiment, wardrobe indicators 122 are powered by rechargeable batteries, however in other embodiments, wardrobe indicators 122 may be powered by other means such as wired connections or wireless energy transfer. In addition, wardrobe indicators 122 may incorporate buttons, switches, or other means of adding to the apparel use count described in step 220.

Furthermore, in the example embodiment, each of wardrobe indicator 122 is assigned a unique identification number which is associated with a particular article of clothing or accessory catalogued in wardrobe database 112. The unique identification number enables each of each wardrobe indicators 122 to be utilized to indicate which specific articles of clothing and accessories are suitable for particular weather conditions and/or occasions. In other embodiments where the clothing and accessories contained within wardrobe 120 are not catalogued in a wardrobe database 112 or do not corresponded with a particular article of clothing, wardrobe indicators 122 may adhere to a section or compartment of wardrobe 120 to indicate which group or compartment of clothing is appropriate for a particular day rather than a specific article. While in the example embodiment wardrobe indicators 122 are individual and unique indicators capable of being attached to clothing and objects, in other embodiments wardrobe indicators 122 may be light-emitting devices along the rails or drawers of wardrobe 120, light-emitting devices built into hangers, monitors/screens displaying images of the suitable clothing, or motorized systems that bring appropriate clothes to the front of wardrobe 120. In the example embodiment, wardrobe indicators 122 are capable of communication with other devices, such as server 110, via a network such as network 108.

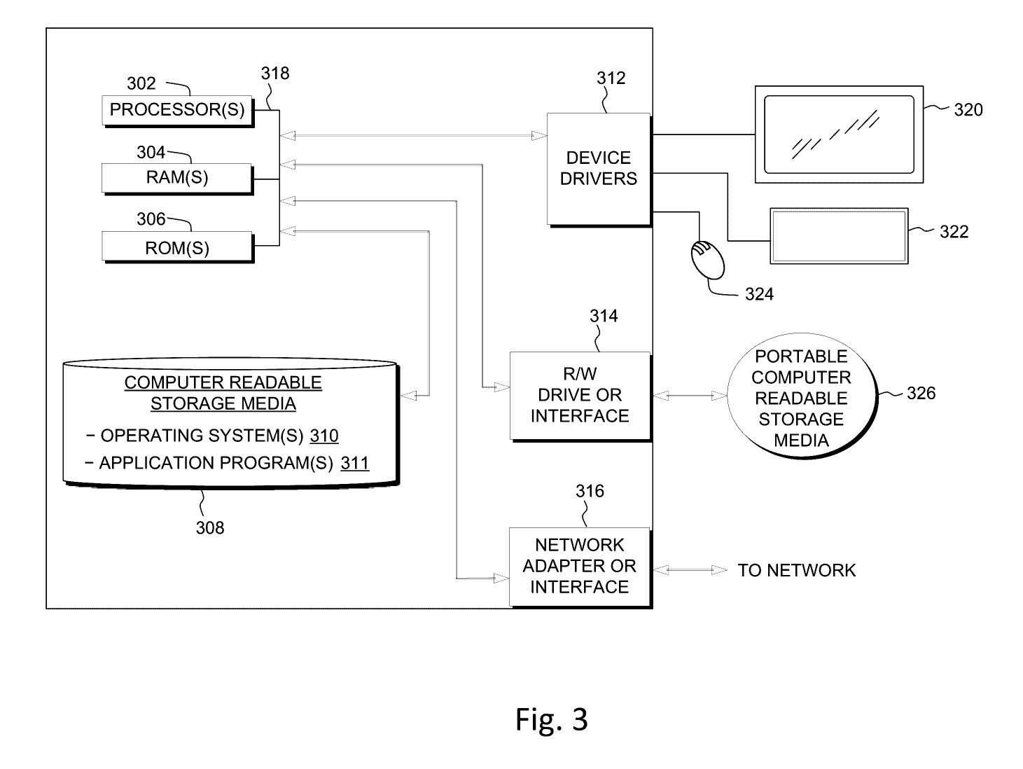

Server 110 includes wardrobe database 112, weather reporting service 114, user schedule 116, and intelligent wardrobe program 118. In the example embodiment, server 110 may be a laptop computer, a notebook, tablet computer, netbook computer, personal computer (PC), a desktop computer, a personal digital assistant (PDA), a smart phone, a thin client, or any other electronic device or computing system capable of receiving and sending data to and from other computing devices. In addition, in the example embodiment, server 110 is equipped with a camera. While server 110 is shown as a single device, in other embodiments, server 110 may be comprised of a cluster or plurality of computing devices, working together or working separately. Server 110 is described in more detail with reference to FIG. 3.

Wardrobe database 112 is an organized collection of data detailing the clothing and accessories contained in wardrobe 120. Wardrobe database 112 may be populated with information associated with clothing and accessories via manual user entry through a user interface on server 110, scanning of universal product codes (UPCs), or from other means such as accessing purchase histories of the user. In the example embodiment, the clothing and accessories information contained in wardrobe database 112 may be associated with corresponding wardrobe indicators 122 such that when intelligent wardrobe program 118 determines which articles of clothing are appropriate, wardrobe indicators 122 are used to indicate said clothing. In the example embodiment, wardrobe database 112 is stored locally on server 110, however in other embodiments database 112 may be stored remotely and accessed via a network such as network 108.

Weather reporting service 114 is a database containing information detailing weather conditions from all over the world. In the example embodiment, weather reporting service 114 is utilized by intelligent wardrobe program 118 as a factor in determining which clothes are suitable for a particular day and location. Additionally, weather reporting service 114 is capable of accessing network 108 and is frequently updated to reflect the aforementioned information as accurately as possible.

User schedule 116 includes information detailing the schedule of the owner of wardrobe 120. In the example embodiment, user schedule 116 is input by the user via a user interface on server 110, however in other embodiments user schedule 116 may be imported work schedules or personal planners. User schedule 116 may include information such as departure times, arrival times, departure dates, arrival dates, and destinations corresponding to the user. Furthermore, in the example embodiment, user schedule 116 may include scheduled business and leisure trips. In the example embodiment, user schedule 116 can be received in advance and be repeated on a daily, weekly, monthly or yearly basis.

In the example embodiment, intelligent wardrobe program 118 is a software application capable of analyzing user schedule 116 and weather reporting service 114 to determine which clothing and/or accessories catalogued in wardrobe database 112 are suitable for a particular day and occasion. Additionally, intelligent wardrobe program 118 is further capable of transmitting a signal corresponding to the determined suitable clothing and/or accessories to wardrobe indications 122. Intelligent wardrobe program 118 is further capable of tracking the frequency of clothing and/or accessories use in order to provide the user with useful information such as apparel use statistics, recommendations to donate or sell infrequently worn articles, and alerting the user of sales on frequently worn articles. While intelligent wardrobe program 118 is stored locally on server 110 in the example embodiment, intelligent wardrobe program 118 may be stored remotely and accessed via a network, such as network 108, in other embodiments.

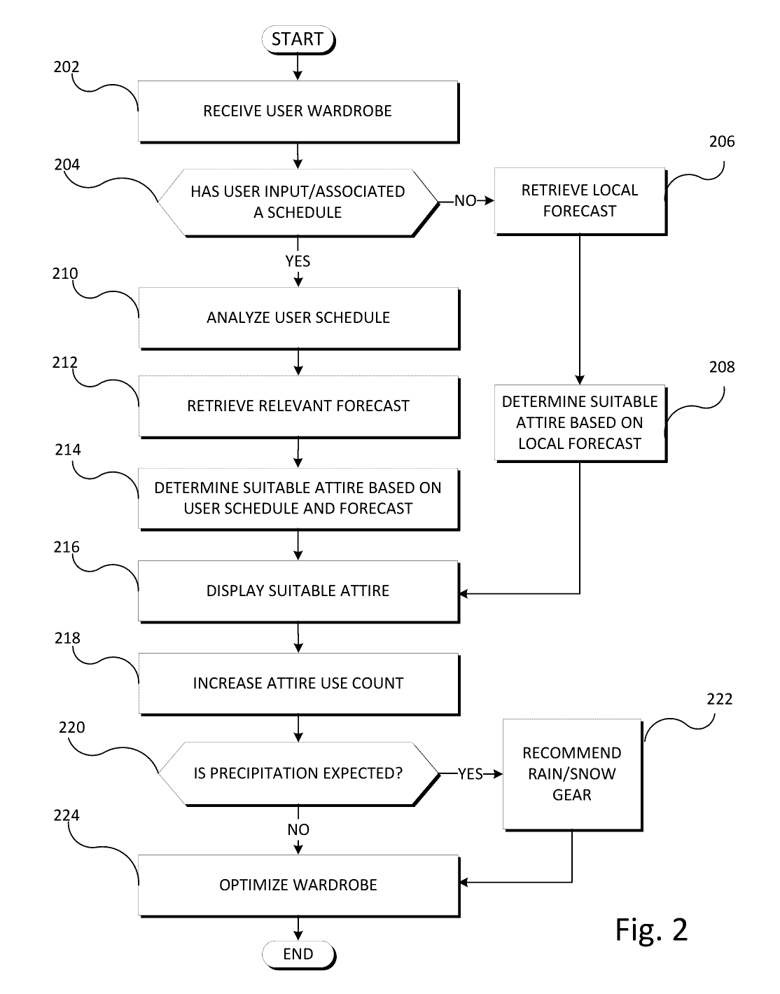

FIG. 2 is a flowchart depicting the operations of intelligent wardrobe program 118 in determining which clothing and/or accessories are suitable for a particular day and occasion. In the example embodiment, intelligent wardrobe program 118 receives the wardrobe database 112 by way of manual user entry through a user interface on server 110 (step 202). In the example embodiment, the user may enter their wardrobe into wardrobe database 112 through a user interface on server 110 by detailing clothing characteristics which may include brand, color, size, sleeve length, dress code, fabric/material, and a picture of the article. In other embodiments, wardrobe database 112 may be populated by way of scanning universal product codes (UPCs) or by other means such as accessing purchase histories of the user. While in the example embodiment wardrobe database 112 is stored locally on server 110, in other embodiments wardrobe database 112 may be stored remotely and accessed via a network, such as network 108.

Intelligent wardrobe program 118 determines whether the user has input or associated a user schedule, such as user schedule 116, by consulting server 110 (step 204).

If the user has not input or associated user schedule 116 (decision 204 “NO” branch), then intelligent wardrobe program 118 retrieves the local forecast in order to suggest clothing based on the local conditions (step 206). Intelligent wardrobe program 118 suggests clothing based on the local forecast because without analyzing user schedule 116, intelligent wardrobe program 118 cannot determine where the user may be throughout the course of the day or days. Therefore, intelligent wardrobe program 118 suggests clothing for the immediately surrounding weather conditions of the user by default. In the example embodiment, intelligent optimizer 114 determines the current location of the user via user input or methods such as a reverse DNS (Domain Name System) lookup of the IP (Internet Protocol) address of the user. Intelligent wardrobe program 118 may then retrieve the local forecast from weather reporting service 114 via network 108. For example, if a user has not input or associated a schedule but resides in New York, N.Y., then intelligent wardrobe program 118 will retrieve the local weather in NY, N.Y.

Based on the local forecast, intelligent wardrobe program 118 determines suitable attire from wardrobe database 112 (step 208). Because the user has not input or associated a schedule, intelligent wardrobe program 118 is unable to determine a dress code and therefore suggests clothing based on temperature alone. In the example embodiment where the clothing of the user is catalogued in wardrobe database 112, intelligent wardrobe program 118 determines which specific articles of clothing are suitable based on comparing the retrieved weather conditions with the individual characteristics of the clothing catalogued in wardrobe database 112. For example, on an eighty (80) degree Fahrenheit day, intelligent wardrobe program 118 may recommend a specific short sleeve casual shirt and a specific short sleeve business shirt. In other embodiments where the clothing of the user is not catalogued in wardrobe database 112, the user may associate wardrobe indicators 122 with compartments of wardrobe 120 of like clothing. The user may further associate each compartment and corresponding wardrobe indicator 122 with a temperature range or specific class of clothing such that intelligent wardrobe program 118 is capable of determining which category of clothing is suitable based on comparing the retrieved weather conditions with the known compartments of wardrobe 120. Using the example above of an eighty (80) degree Fahrenheit day, if user inputs that a first indicator of wardrobe indicators 122 corresponds to the entire collection of short sleeves shirts of the user, then intelligent wardrobe program 118 will transmit a signal to the first indicator of wardrobe indicators 122 (illuminating the first indicator) corresponding to the entire short sleeve shirt compartment of wardrobe 120, including both business and casual dress.

If the user has input or associated a schedule (decision 204 “YES” branch), intelligent optimizer program 118 analyzes user schedule 116 in order to determine the dress code and location of scheduled events (step 210). Intelligent wardrobe program 118 scans user schedule 116 for keywords or other indicators to determine what dress code is appropriate for particular occasions. Keywords/indicators may be specified by user input or preloaded into intelligent wardrobe program 118 and include words such as “work,” “gym,” “business,” “meeting,” “casual,” and the like. The user-specified or preloaded keywords are associated with dress codes, such as gym wear, streetwear, casual, business casual, smart casual, business/informal, and black tie/semi-formal, such that when detecting the presence of one or more of the keywords/indicators, intelligent wardrobe program 118 can determine which dress code is appropriate for the particular occasion. These associations are either user input or preloaded into intelligent wardrobe program 118. For example, the keyword “gym” would indicate a gym wear dress code while the keyword “meeting” would indicate a business/informal dress code. Similarly, intelligent wardrobe 118 scans user schedule 116 to determine the scheduled destinations of the user in order to obtain the most relevant forecast. Intelligent wardrobe program 118 scans for locational keywords/indicators that are user input or preloaded and may include addresses, buildings, cities, states, landmarks, and other location-specific indicators. Intelligent wardrobe program 118 associates the location keywords/indicators with the corresponding locations in order to retrieve a forecast most relevant to the user. Furthermore, intelligent wardrobe program 118 determines the duration of scheduled events such as business and leisure trips by scanning user schedule 116 for the start and end times of events along with hotel and travel accommodations. If the user has a future trip planned, intelligent wardrobe program 118 will suggest proper clothing corresponding to the forecast of the location of the scheduled destination(s) as well as suggest clothing for every day and night for the duration of the scheduled trip, similar to a packing list. In the event the plans of the user change and user schedule 116 is not updated, these determinations are capable of being overridden by the user. While in this embodiment intelligent wardrobe program 118 scans user schedule 116, in other embodiment's dress code and location may be input by the user manually through a user interface on server 110.

Intelligent wardrobe program 118 retrieves the relevant forecast from weather reporting service 114 (step 212). In the example embodiment, the relevant forecast corresponds to the determined destination(s) and scheduled times of the user obtained from user schedule 116. Furthermore, in the example embodiment, intelligent wardrobe program 118 obtains the relevant forecast on a day to day basis unless the analyzing user schedule 116 in step 210 indicates that the user will be away for multiple days such as a business of leisure trip. If intelligent wardrobe program 118 determines that the user will be away for several days, then intelligent wardrobe program 118 retrieves the forecast for the duration of the trip in order to recommend suitable clothing and overnight wear. For example, if the user is only scheduled to go to work in New York City on a Tuesday and scanning user schedule 116 shows no indications of an overnight stay, then intelligent wardrobe program 118 will only retrieve the weather for Tuesday in New York City to ensure the most up to date and accurate forecast. Conversely, if scanning user schedule 116 indicates the user is scheduled for a flight on Tuesday night and is staying at a hotel in Miami from Tuesday night to Sunday, then intelligent wardrobe program 118 will retrieve the Tuesday forecast in NYC, the Sunday night forecast in NYC, and the forecast in Miami from Tuesday night to Sunday morning.

Intelligent wardrobe program 118 determines suitable attire based on user schedule 116 and the relevant forecast (step 214). Intelligent wardrobe program 118 determines suitable attire by cross referencing the available clothing in wardrobe database 112 with the dress code determined in step 210 and relevant forecast retrieved in step 212. For example, if intelligent wardrobe program 118 determines that the user is scheduled to go to work in NYC and the temperature is eighty (80) degrees Fahrenheit, then intelligent wardrobe program 118 will cross reference this forecast with available business clothes in wardrobe database 112 suitable for a warmer environment. Furthermore, in the example embodiment, intelligent wardrobe program 118 takes into account the frequency and dates particular articles of clothing are worn (attire use count is further explained in step 218). Using an attire use count, intelligent wardrobe program 118 will recommend infrequently worn or long since worn attire depending on the preference of the user. For example, if intelligent wardrobe program 118 determines that three short sleeve shirts are appropriate for a particular day and occasion but two of the three shirts have been worn within the last week, then intelligent wardrobe program 118 will first recommend the shirt that hasn't been worn recently. Similarly, if three shirts are suitable for a particular day and occasion and two of the shirts have been worn six times total while the third shirt has been worn once, then intelligent wardrobe program 118 will recommend the shirt worn only once.

In the example embodiment, intelligent wardrobe program 118 displays the suitable attire by transmitting a signal to each of wardrobe indicators 122 corresponding to the specific suitable attire (step 216). In the example embodiment, intelligent wardrobe program 118 transmits the signal via network 108, however in other embodiments, intelligent wardrobe program 118 transmits the signal via a wired or other connection. In the example embodiment, wardrobe indicators 122 are attachable devices which emit a colored light to indicate that the corresponding clothing and/or accessory are suitable for the particular day and/or occasion specified by user schedule 116 or manual input. In other embodiments, however, wardrobe indicators 122 may be lighting along the rails or drawers of wardrobe 120, light indicators built into hangers within wardrobe 120, monitors/screens displaying pictures of suitable clothing, or motorized systems that bring appropriate clothes to the front of wardrobe 120.

Intelligent wardrobe program 118 increases attire use count for each instance the user wears particular articles of clothing (step 218). In the example embodiment, intelligent wardrobe program 118 determines each instance a particular article of clothing is worn by detecting when a button is pressed on each of wardrobe indicators 122. However, in other embodiments, intelligent wardrobe program 118 may determine each instance a particular article of clothing is worn by other means such as user input on server 110. Alternative embodiments may also include detecting when each of wardrobe indicator 122 are removed from the corresponding piece of clothing using sensors which can detect the presence of fabric or other material, indicating that the clothing article is in use and the use count should be increased. Further embodiments may also include utilizing weight sensors and/or other weight sensing mechanisms built into individual hangers to detect when less weight is applied to the hanger as a result of removing clothing. The detectors may be calibrated by the user via the user interface on server 110 to increase the attire use count when a specific weight loss threshold is detected or the attire use count may be increased when a specified percentage of the existing weight is removed. Similarly, the detectors are reset when the specific weight threshold or weight percentage is added to the hanger. Additional embodiments may also detect when each of wardrobe indicators 122 are placed in a compartment or drawer which is capable of determining which article of clothing is associated with each of wardrobe indicator 122, thus identifying which attire use count to increase. The attire use count is utilized by intelligent wardrobe program 118 in determining which clothes are currently available as well as various wardrobe statistics described in greater detail in step 224.

Intelligent wardrobe program 118 determines whether precipitation is expected by referencing user schedule 116 and the forecast retrieved in step 212 (decision 220). In the example embodiment, intelligent wardrobe program 118 determines the overall chance of precipitation at the location and for the duration that the user is out, according to user schedule 116. In addition, intelligent wardrobe program 118 is further capable of determining the form of precipitation (snow, sleet, rain, etc.) based on the retrieved relevant forecast from weather reporting service 114. For example, if the user is scheduled to be out from noon to one o'clock PM (1:00 PM) in eighty (80) degree Fahrenheit weather and the chances of precipitation are fifty percent (50%) at noon and sixty percent (60%) at one o'clock (1:00 PM), then intelligent wardrobe program 118 determines that the overall chance of rain while the user is out is fifty-five percent (55%) and will recommend clothing/accessories accordingly. While the user may specify the chance of precipitation at which accessories of wardrobe database 112 are recommended, the default recommendations are, for example, recommending an umbrella when the chances of precipitation are fifty percent (50%) or greater.

If intelligent wardrobe program 118 determines that precipitation is expected (decision 220 “YES” branch), intelligent wardrobe program 118 recommends clothing to withstand the precipitation (step 222). In the example embodiment, clothing recommendations are based on the chance of precipitation such that higher chances of precipitation warrant more protective gear. For example, if the chance of precipitation is greater than twenty-five percent (25%) but less than fifty percent (50%), then intelligent wardrobe program 118 may recommend the user bring a light rain coat. However, if the chance of precipitation is greater than eighty percent (80%), then intelligent wardrobe program 118 will recommend bringing an umbrella and/or rain boots. Similarly, if intelligent wardrobe program 118 expects snow, intelligent wardrobe program 118 may recommend snow gloves and other snow apparel, however this and other accessory suggestions are based on the available wardrobe catalogued by the user in wardrobe database 112.

If intelligent wardrobe program 118 determines that precipitation is not expected (decision 220 “NO” branch), then intelligent wardrobe program optimizes wardrobe database 112 (step 224). In the example embodiment where intelligent wardrobe program 118 is connected to network 108, intelligent wardrobe program 118 optimizes wardrobe database 112 in several ways which include suggesting that the user donate infrequently worn clothing to charity, recommending when to wash apparel, communicating with other intelligent wardrobes to borrow and share clothing, communicating with clothing retailers to rent clothing for future events scheduled in user schedule 116, and alerting the user of sales on frequently worn or needed apparel through communication with online retailers. For example, if the attire use count indicates that a particular shirt has not been worn in two years and also indicates that the majority of the shirts worn by the user over the past six months are two sizes larger than the particular shirt, then intelligent wardrobe program 118 will recommend selling or donating the shirt. If desired, the user can sell the shirt by importing the information corresponding to the shirt from wardrobe database 112 to an online consignment or retail shop. Similarly, if the user frequently wears dress shirts of a particular brand and style but only has four of them, intelligent wardrobe program 118 will detect and alert the user to sales of the particular shirt, style, and brand. Furthermore, if the user has a formal occasion in the near future and wardrobe database 112 does not catalogue any formal wear appropriate for the occasion, then intelligent wardrobe program 118 may communicate with online retailers or other linked intelligent wardrobes to reserve clothing for particular occasions or vacations (linking intelligent wardrobes may be accomplished through user input by, for example, sending link requests to friends).

FIG. 3 depicts a block diagram of components of server 110 of an intelligent wardrobe system 100 of FIG. 1, in accordance with an embodiment of the present invention. It should be appreciated that FIG. 3 provides only an illustration of one implementation and does not imply any limitations with regard to the environments in which different embodiments may be implemented. Many modifications to the depicted environment may be made.

Server 110 may include one or more processors 302, one or more computer-readable RAMs 304, one or more computer-readable ROMs 306, one or more computer readable storage media 308, device drivers 312, read/write drive or interface 314, network adapter or interface 316, all interconnected over a communications fabric 318. Communications fabric 318 may be implemented with any architecture designed for passing data and/or control information between processors (such as microprocessors, communications and network processors, etc.), system memory, peripheral devices, and any other hardware components within a system.

One or more operating systems 310, and one or more application programs 311, for example, intelligent wardrobe program 118, are stored on one or more of the computer readable storage media 308 for execution by one or more of the processors 302 via one or more of the respective RAMs 304 (which typically include cache memory). In the illustrated embodiment, each of the computer readable storage media 308 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Server 110 may also include a R/W drive or interface 314 to read from and write to one or more portable computer readable storage media 326. Application programs 311 on server 110 may be stored on one or more of the portable computer readable storage media 326, read via the respective R/W drive or interface 314 and loaded into the respective computer readable storage media 308.

Server 110 may also include a network adapter or interface 316, such as a TCP/IP adapter card or wireless communication adapter (such as a 4G wireless communication adapter using OFDMA technology). Application programs 311 on server 110 may be downloaded to the computing device from an external computer or external storage device via a network (for example, the Internet, a local area network or other wide area network or wireless network) and network adapter or interface 316. From the network adapter or interface 316, the programs may be loaded onto computer readable storage media 308. The network may comprise copper wires, optical fibers, wireless transmission, routers, firewalls, switches, gateway computers and/or edge servers.

Server 110 may also include a display screen 320, a keyboard or keypad 322, and a computer mouse or touchpad 324. Device drivers 312 interface to display screen 320 for imaging, to keyboard or keypad 322, to computer mouse or touchpad 324, and/or to display screen 320 for pressure sensing of alphanumeric character entry and user selections. The device drivers 312, R/W drive or interface 314 and network adapter or interface 316 may comprise hardware and software (stored on computer readable storage media 308 and/or ROM 306).

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Based on the foregoing, a computer system, method, and computer program product have been disclosed. However, numerous modifications and substitutions can be made without deviating from the scope of the present invention. Therefore, the present invention has been disclosed by way of example and not limitation.

Various embodiments of the present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for an intelligent wardrobe, the method comprising:
receiving information detailing a wardrobe of a user, wherein the wardrobe of the user includes one or more apparel items, and wherein the one or more apparel items includes one or more of one or more clothing items and one or more accessories;
identifying at least one of a user schedule and information detailing weather conditions, wherein the user schedule includes information detailing a dress code and one or more locations of one or more events;
determining at least one of the one or more apparel items from the wardrobe of the user based on cross referencing the wardrobe of the user with at least one of the identified dress code and the identified information detailing weather conditions; and
transmitting a signal to one or more wardrobe indicators corresponding to the determined at least one of the one or more apparel items of the wardrobe of the user,
wherein one or more steps of the above method are performed using one or more computers.

2. The method of claim 1, wherein the information detailing the wardrobe of the user is populated by methods including user input, scanning Universal Product Codes, retrieving information from purchase histories of the user, and retrieving information from credit card statements of the user.

3. The method of claim 1, wherein the information detailing weather conditions includes weather conditions of the one or more locations designated in the user schedule.

4. The method of claim 1, wherein the wardrobe indicators include one or more of light emitting devices fixed to one or more of hangers and apparel items, one or more light emitting devices fixed to one or more of a rail and a drawer of the user wardrobe, light emitting devices built into one or more hangers within the user wardrobe, one or more monitors displaying the determined at least one of the one or more apparel items, and a motorized system that brings the determined at least one of one or more apparel items to a front side of the wardrobe of the user.

5. The method of claim 1, wherein determining the at least one of the one or more apparel items is further based on an attire use count, wherein the attire use count is an amount of instances that the one or more apparel items are utilized, and wherein the attire use count is increased based on at least one of detecting when a button is pressed on the one or more wardrobe indicators, detecting when the one or more wardrobe indicators are removed from the one or more apparel items, detecting a weight fluctuation on one or more hangers when one or more apparel items are removed, and detecting when the one or more wardrobe indicators are placed in a specified area capable of determining one or more apparel items corresponding to the one or more wardrobe indicators.

6. The method of claim 1, further comprising at least one of:
recommending apparel items of the one or more apparel items with a low attire use count be donated to charity;
recommending apparel items of the one or more apparel items with a low attire use count be sold;
listing apparel items of the one or more apparel items with a low attire use count for sale; and
alerting the user of sales on apparel items similar to the one or more apparel items in the wardrobe of the user.

7. The method of claim 1, wherein the dress code is determined by scanning the user schedule for one or more keywords and cross referencing the at least one of the one or more keywords with a database, and wherein the database includes associations between the one or more keywords and one or more dress codes.

8. A computer program product for an intelligent wardrobe program, the computer program product comprising:
one or more computer-readable storage media and program instructions stored on the one or more computer-readable storage media, the program instructions comprising:
program instructions to receive information detailing a wardrobe of a user, wherein the wardrobe of the user includes one or more apparel items, and wherein the one or more apparel items includes one or more clothing items and accessories;
program instructions to identify at least one of a user schedule and information detailing weather conditions, wherein the user schedule includes information detailing a dress code and one or more locations of one or more events;
program instructions to determine at least one of the one or more apparel items from the wardrobe of the user based on cross referencing the wardrobe of the user with at least one of the identified dress code and the identified information detailing weather conditions; and
program instructions to transmit a signal to one or more wardrobe indicators corresponding to the determined at least one of the one or more apparel items of the wardrobe of the user.

9. The computer program product of claim 8, wherein the information detailing the wardrobe of the user is populated by methods including user input, scanning Universal Product Codes, retrieving information from purchase histories of the user, and retrieving information from credit card statements of the user.

10. The computer program product of claim 8, wherein the information detailing weather conditions includes weather conditions of the one or more locations designated in the user schedule.

11. The computer program product of claim 8, wherein the wardrobe indicators include one or more of light emitting devices fixed to one or more of hangers and apparel items, one or more light emitting devices fixed to one or more of a rail and a drawer of the user wardrobe, light emitting devices built into one or more hangers within the user wardrobe, one or more monitors displaying the determined at least one of the one or more apparel items, and a motorized system that brings the determined at least one of one or more apparel items to a front side of the wardrobe of the user.

12. The computer program product of claim 8, wherein determining the at least one of the one or more apparel items is further based on an attire use count, wherein the attire use count is an amount of instances that the one or more apparel items are utilized, and wherein the attire use count is increased based on at least one of detecting when a button is pressed on the one or more wardrobe indicators, detecting when the one or more wardrobe indicators are removed from the one or more apparel items, detecting a weight fluctuation on one or more hangers when one or more apparel items are removed, and detecting when the one or more wardrobe indicators are placed in a specified area capable of determining one or more apparel items corresponding to the one or more wardrobe indicators.

13. The computer program product of claim 8, further comprising at least one of:
program instructions to recommend apparel items of the one or more apparel items with a low attire use count be donated to charity;
program instructions to recommend apparel items of the one or more apparel items with a low attire use count be sold;
program instructions to list apparel items of the one or more apparel items with a low attire use count for sale; and
program instructions to alert the user of sales on apparel items similar to the one or more apparel items in the wardrobe of the user.

14. The computer program product of claim 8, wherein the dress code is determined by scanning the user schedule for one or more keywords and cross referencing the at least one of the one or more keywords with a database, and wherein the database includes associations between the one or more keywords and one or more dress codes.

15. A computer system for an intelligent wardrobe program, the computer system comprising:
one or more computer processors, one or more computer-readable storage media, and program instructions stored on one or more of the computer-readable storage media for execution by at least one of the one or more processors, the program instructions comprising:
program instructions to receive information detailing a wardrobe of a user, wherein the wardrobe of the user includes one or more apparel items, and wherein the one or more apparel items includes one or more clothing items and accessories;
program instructions to identify at least one of a user schedule and information detailing weather conditions, wherein the user schedule includes information detailing a dress code and one or more locations of one or more events;
program instructions to determine at least one of the one or more apparel items from the wardrobe of the user based on cross referencing the wardrobe of the user with at least one of the identified dress code and the identified information detailing weather conditions; and
program instructions to transmit a signal to one or more wardrobe indicators corresponding to the determined at least one of the one or more apparel items of the wardrobe of the user.

16. The computer system of claim 15, wherein the information detailing the wardrobe of the user is populated by methods including user input, scanning Universal Product Codes, retrieving information from purchase histories of the user, and retrieving information from credit card statements of the user.

17. The computer system of claim 15, wherein the information detailing weather conditions includes weather conditions of the one or more locations designated in the user schedule.

18. The computer system of claim 15, wherein the wardrobe indicators include one or more of light emitting devices fixed to one or more of hangers and apparel items, one or more light emitting devices fixed to one or more of a rail and a drawer of the user wardrobe, light emitting devices built into one or more hangers within the user wardrobe, one or more monitors displaying the determined at least one of the one or more apparel items, and a motorized system that brings the determined at least one of one or more apparel items to a front side of the wardrobe of the user.

19. The computer system of claim 15, wherein determining the at least one of the one or more apparel items is further based on an attire use count, wherein the attire use count is an amount of instances that the one or more apparel items are utilized, and wherein the attire use count is increased based on at least one of detecting when a button is pressed on the one or more wardrobe indicators, detecting when the one or more wardrobe indicators are removed from the one or more apparel items, detecting a weight fluctuation on one or more hangers when one or more apparel items are removed, and detecting when the one or more wardrobe indicators are placed in a specified area capable of determining one or more apparel items corresponding to the one or more wardrobe indicators.

20. The computer system of claim 15, wherein the dress code is determined by scanning the user schedule for one or more keywords and cross referencing the at least one of the one or more keywords with a database, and wherein the database includes associations between the one or more keywords and one or more dress codes.
